(19) United States
(12) Patent Application Publication
(10) Pub. No.: US 2015/0086785 A1
(43) Pub. Date: Mar. 26, 2015

(54) REINFORCED POLYOLEFIN COMPOSITIONS AND RELATED PRODUCTS AND METHODS

(71) Applicant: American Selenite, LLC, Denver, CO (US)

(72) Inventor: George C. Hawley, Cornwall (CA)

(21) Appl. No.: 14/388,615

(22) PCT Filed: Mar. 27, 2013
(86) PCT No.: PCT/US2013/034020

§ 371 Date: Sep. 26, 2014

Related U.S. Application Data
(60) Provisional application No. 61/618,730, filed on Mar. 31, 2012.

(51) Int. Cl. C08K 3/30; B29C 45/00

(52) U.S. Cl. CPC C08K 3/30; B29C 45/0001; C08K 2003/3045; B29K 2023/12
USPC 428/402; 524/423; 264/328.1

(57) ABSTRACT

A granular particulate anhydrite reinforcing agent for polyolefin compositions may be used at a low concentration to provide enhanced composition properties, and particularly in relation to flexural properties.

### REFERENCE TO RELATED APPLICATIONS

This application claims the benefit of U.S. provisional patent application No. 61/618,730, filed Mar. 31, 2012, the entire contents of which are incorporated by reference herein as if set forth herein in full.

### FIELD OF THE INVENTION

The invention relates to reinforcing agents for polyolefin polymers, reinforced polyolefin compositions and related products and methods.

### BACKGROUND OF THE INVENTION

Polyolefins, such as polyethylene, polypropylene and ethylene-propylene copolymers, are used in a variety of applications. One significant application is for use in transportation vehicles, and particularly automobiles, for both internal and external components. For example, polypropylene is a widely used in automobile applications. However, for many applications, polypropylene lacks sufficient rigidity for optimal performance. Reinforcing fillers may be added to help improve flexural properties for enhanced rigidity. Many of these reinforcing fillers have a platy particle morphology (e.g., talc) or fiber-shaped particle morphology with a high aspect ratio (e.g., glass fibers, wollastonite). Talc may require high concentrations to obtain significantly improved flexural properties, which may significantly increase the density of the reinforced polypropylene composition and accordingly also the weight of the transportation vehicle. Fiber-shaped reinforcement fillers may permit the use of lower concentrations to achieve significant improvement in flexural properties, but fiber-shaped materials tend to be more expensive and are not necessarily easy to handle or readily disperse in the polymer.

### SUMMARY OF THE INVENTION

A first aspect of the invention involves reinforced polyolefin composition comprising a polyolefin polymer component and a granular particulate anhydrite reinforcing agent, or filler. The anhydrite reinforcing agent is comprised of granular particles having a small weight average particle size. The reinforcing agent may be used at a low loading, or concentration, to enhance flexural properties (e.g., flexural strength, flexural modulus) for use in a variety of applications. Surprisingly, the anhydrite reinforcing agent provides a reinforcement benefit without significant degradation of notched impact strength. Rather, notched impact strength may also increase with use of the anhydrite reinforcing agent at low loading levels. This is a significant benefit for polyolefin compositions, which may otherwise suffer from low notched impact strength. The granular particulate anhydrite reinforcing agent provides an alternative to the use of fiber reinforcing agents for many applications.

A number of feature refinements and additional features are applicable to the first aspect of the invention. These feature refinements and additional features may be used individually or in any combination. As such, each of the following features may be, but are not required to be, used with any other feature or combination of the first aspect.

The polyolefin polymer component may be comprised of only a single polyolefin polymer or may comprise a blend of different polyolefin polymers. A polyolefin polymer of the polyolefin polymer component may be a homopolymer or a copolymer. Such a copolymer may be a copolymer including ethylene and propylene repeating units. Such a polyolefin homopolymer may be a polyethylene homopolymer or a polypropylene homopolymer. In preferred implementations the polyolefin component comprises polypropylene homopolymer. The anhydrite reinforcing agent may be in the form of soluble anhydrite, insoluble anhydrite or a combination of soluble and insoluble anhydrite.

In preferred implementations, the anhydrite reinforcing agent comprises insoluble anhydrite. The anhydrite reinforcing agent may comprise less than 0.5 weight percent, less than 0.3 weight percent, less than 0.25 weight percent or even less than 0.2 weight percent of water.

By granular, it is meant that the anhydrite reinforcing agent is in a particulate form comprising mostly or substantially only particles that are not substantially elongated in shape, in that the particles may have a low aspect ratio (ratio of particle length to diameter). The anhydrite particles may have an aspect ratio of smaller than 3:1, smaller than 2:1 smaller than 1.5:1, smaller than 1.25:1 or approximately 1:1 (no elongation). The granular shape of particles of the anhydrite reinforcing agent may result from comminution of anhydrite material, or from comminution or of calcium sulfate dihydrate or hemi-hydrate, which may be a mineral form (e.g., gypsum), that is then calcined to form anhydrite. The anhydrite reinforcing agent may have a weight-average particle size of at least 0.5 micron, 1 micron, 1.5 microns, 2 microns or 3 microns. The anhydrite reinforcing agent may have a weight average particle size that is no larger than 20 microns, 15 microns, 12 microns, 10 microns, 8 microns, 6 microns, 5 microns, 4 microns or 3 microns. In some preferred embodiments, the anhydrite reinforcing agent has a weight average particle size in a range of from 2 microns to 10 microns. The anhydrite reinforcing agent may have a particle size distribution such that at least 90 weight percent of the particles are smaller than 5 times the weight average particle size, 4 times the weight average particle size, 3 times the weight average particle size or 2 times the weight average particle size. The anhydrite reinforcing agent may have a particle size distribution such that at least 90 weight percent of the particles are larger than 0.2 times the weight average particle size, 0.25 times the weight average particle size, 0.3 times the weight average particle size or 0.4 times the weight average particle size. In some preferred embodiments, the anhydrite reinforcing agent has a particle size distribution such that at least 90 weight percent of the particles of the anhydrite reinforcing agent are no larger than 60 microns, 50 microns, 40 microns, 30 microns, 20 microns, 15 microns, 10 microns, 7 microns, 6 microns or 5 microns. The anhydrite reinforcing agent may have a particle size distribution such that at least 90 weight percent of the particles of the anhydrite reinforcing agent are at least 0.1 micron, 0.25 micron, 0.5 micron, 1 micron or 2 microns. As will be appreciated, a weight average particle size means that 50 percent by weight of the particles are larger and 50 percent by weight of the particles are smaller than that size. Such a size is often referred to as a “D50” particle size. Likewise, a size at which 90 weight percent of the particles are smaller than that size may be referred to as the “D90” size, a size at which 10 weight percent of the particles are smaller than that size may be referred to as the “D10” size.

The anhydrite reinforcing agent may have a purity of at least 90 percent, at least 95 percent, at least 97 percent, at least 98 percent or at least 99 percent. By having a purity of at least a certain percentage, it is meant that anhydrite makes up at least that weight percentage of the anhydrite reinforcing agent.

The anhydrite reinforcing agent may comprise particles that are surface-treated, for example to promote thorough mixing and dispersion of the reinforcing agent particles in the polyolefin component. Such surface-treated particles may be surface-treated with one or more of the following: a silane, aluminate, a titanate, a zirconaluminate and a fatty acid. Surface treatment of such surface-treated particles may include a material covalently coupled with or adhered to (e.g., adsorbed, physically absorbed, chemisorbed) to a surface of the anhydrite particles. Alternatively, the particles of the anhydrite reinforcing agent may be not surface-treated, in that the surface of the particles has not been chemically treated to modify anhydrite surface properties.

Anhydrite particles of the anhydrite reinforcing agent may be substantially nonporous particles. Anhydrite particles of the anhydrite reinforcing agent may have a specific gravity that is substantially that of pure anhydrite. The anhydrite reinforcing agent may have a bulk density of at least 0.2 gram per cubic centimeter, 0.3 gram per cubic centimeter or 0.4 gram per cubic centimeter. The anhydrite reinforcing agent may have a bulk density of not more than 1 gram per cubic centimeter, 0.9 gram per cubic centimeter, 0.8 gram per cubic centimeter, 0.7 gram per cubic centimeter or 0.6 gram per cubic centimeter.

The reinforced polyolefin composition may comprise the anhydrite reinforcing agent in an amount in a range having a lower limit of 1.5 weight percent, 2 weight percent, 2.5 weight percent, 3 weight percent or 4 weight percent weight percent and an upper limit of 17 weight percent, 15 weight percent, 12 weight percent, 10 weight percent, 7.5 weight percent, 6 weight percent or 5 weight percent. For some preferred embodiments, the anhydrite reinforcing agent is present in an amount of from 2.5 to 7.5 weight percent of the reinforced polyolefin composition.

The reinforced polyolefin composition may comprise the polyolefin polymer component in an amount of at least 80 weight percent, 85 weight percent, 90 weight percent, 93 weight percent, 95 weight percent or 97 weight percent. The reinforced polyolefin composition may comprise the polyolefin polymer component in an amount of not more than 98 weight percent, 97 weight percent or 95 weight percent.

The reinforced polyolefin composition may include one or more minor components in addition to the polyolefin polymer component and the anhydrite reinforcing agent. Such a minor component may include, for example, a pigment, processing aid or stabilizer. The total of all components in the reinforced polyolefin composition other than the polyolefin polymer component and the anhydrite reinforcing agent may be present in an amount of no more than 10 weight percent, 5 weight percent, 3 weight percent or 2 weight percent.

The reinforced polyolefin composition may have a flexural strength (e.g., per ASTM D790) of at least 6000 psi, at least 6100 psi, at least 6200 psi, at least 6300 psi, at least 6500 psi or at least 6700 psi. The reinforced polyolefin composition may have a flexural strength of (e.g., per ASTM D790) of at least 10%, 15%, 20% or 25% larger than the flexural strength of a comparison composition that is the same as the reinforced polyolefin composition except without the anhydrite reinforcing agent. The reinforced polyolefin composition may have a flexural modulus, tangent, (e.g., per ASTM D790) of at least 220 kpsi, 225 kpsi, 230 kpsi, 250 kpsi, 275 kpsi or 300 kpsi. The reinforced polyolefin composition may have a flexural modulus, tangent (e.g., per ASTM D790) of at least 15%, 20%, 25%, 30% or 35% greater than the flexural modulus, tangent of a comparison composition that is the same as the reinforced polyolefin composition except without the anhydrite reinforcing agent.

The reinforced polyolefin composition may have a notched Izod impact strength (e.g., per ASTMcD256) of at least 0.5, at least 0.52, at least 0.54 or at least 0.57 ft-lb/in.

The reinforced polyolefin composition may have a heat deflection temperature (e.g., per ASTMD 648) at 66 psi of at least 58° C., at least 59° C., at least 60° C., at least 63° C., at least 65° C. or at least 70° C.; and at 264 psi of at least 95° C., at least 97° C., at least 100° C., at least 105° C., at least 110° C. or at least 115° C.

The reinforced polyolefin composition may have a specific gravity of smaller than 1.015 grams per cubic centimeter, 1.1 grams per cubic centimeter, 1 gram per cubic centimeter, 0.97 gram per cubic centimeter, 0.94 gram per cubic centimeter or 0.925 gram per cubic centimeter.

The reinforced polyolefin composition may have a melt flow index in grams per 10 minutes (e.g., per ASTM D1238, 230° C., 2.16 kilogram) of less than 20, less than 15, less than 13 or less than 12. The reinforced polyolefin composition may have such a melt flow index that is no more than 25 percent, no more than 20 percent, no more than 15 percent, or no more than 10 percent greater than a melt flow index of a comparison composition that is the same as the reinforced polyolefin composition except excluding the reinforcing agent.

The reinforced polyolefin composition may be in the form of a product. The product may be a product for use in a transportation vehicle. The transportation vehicle may be a wheeled transportation vehicle, such as an automobile (e.g., passenger automobile, bus, truck) or a rail vehicle (e.g., a train). The transportation vehicle may be an aviation vehicle (e.g., airplane, helicopter). The product may be an interior component of such a transportation vehicle or may be an exterior component of such a transportation vehicle. The product form may be a bumper cover, or portion thereof, for a wheeled transportation vehicle. The product form may be a dashboard, or a portion thereof, for a transportation vehicle.

A second aspect of the invention involves a product comprising the reinforced polyolefin composition of the first aspect of the invention.

A number of feature refinements and additional feature are applicable to the second aspect of the invention. These feature refinements and additional features may be used individually or in any combination. As such, each of the following features may be, but are not required to be used with any feature combination of the second aspect.

The product may be any of the product forms described with respect to the first aspect of the invention. The product may be an injection molded product.

A third aspect of the invention involves a method for making a product comprising the reinforced polyolefin composition of the first aspect of the invention. The method or use comprises injection molding the reinforced polyolefin composition into a desired product form.

A fourth aspect of the invention involves use of reinforced polyolefin composition of the first aspect of the invention to manufacture an injection-molded part for a transportation vehicle.

A number of feature refinements and additional features are applicable to the third and fourth aspects of the invention. These feature refinements and additional features may be used individually or in any combination. As such, each of the following features may be but are not required to be used with any other feature or combination of the third or fourth aspects.

The product may be as described with respect to the first aspect or the second aspect of the invention.

A fifth aspect of the invention provides a granular particulate anhydrite reinforcing agent product. The granular particulate anhydrite reinforcing agent product may be as described with respect to the granular anhydrite reinforcing agent of the first aspect of the invention.

Additional aspects and additional features and feature refinements that may be used with any of the aspects of the invention are provided within the discussion below.

### DETAILED DESCRIPTION

Anhydrite, or anhydrous calcium sulfate, may be prepared by calcination of calcium sulfate dihydrate (e.g., gypsum) or calcium sulfate hemi-hydrate to drive off bound water. “Soluble” anhydrite refers to anhydrite that will readily take up water when exposed to moisture and “insoluble” anhydrite refers to anhydrite that will not take up significant water when exposed to moisture. Preparing insoluble anhydrite generally requires significantly higher calcination temperatures than required to prepare soluble anhydrite. Insoluble anhydrite also sometimes referred to as “dead burned” anhydrite.

As used herein, “particulate” and “particulate form” mean that a material is in the form of a batch of particles, regardless of whether the batch of particles is separate from other materials or is intimately mixed with other materials (e.g., particulate reinforcing agent mixed with a polyolefin polymer component).

Surprisingly, it has been found that the granular particulate anhydrite reinforcing agent of a fine particle size may be advantageously used to prepare reinforced polyolefin compositions with significant improvement in mechanical properties, and especially flexural properties, at a low loading (concentration) of the reinforcing agent.

### EXAMPLES

Some aspects of the present invention are further described in the following examples that are intended as illustrations only. Unless otherwise noted, all parts, percentages and ratios reported in the following examples are on a weight basis.

Five different sample calcium sulfate powders are tested for use as a reinforcing agent in polypropylene. The powders tested as sample reinforcing agents are summarized in Table 1.

TABLE 1

| Sample | | |
|---|---|---|
| Reinforcing Agent | Powder Particulate Type | Calcium Sulfate Form |
| WA | Commercially available whisker product | Hydrated between hemi- |
| | with high aspect ratio calcium sulfate | hydrate and anhydrite, |
| | whiskers (fibers) on the order of tens of | initially containing about 3% |
| | microns or more in length, also | water |
| | including some larger chunks | |
| WB | Whisker product of WA after calcining | Hydrated between hemi- |
| | for 3 hours at 110° C. | hydrate and anhydrite, with |
| | | lower water content than WA |
| WC | Whisker product of WA after calcining | Soluble anhydrite |
| | for 3 hours at 210° C. | |
| WD | Whisker product of WA after calcining | Insoluble anhydrite |
| | for 3 hours at 650° C. | |
| G | Granular powder with D50 of about 12 | Insoluble anhydrite |
| | microns, D10 of about 3 microns and | |
| | D90 of about 52 microns (by laser | |
| | analysis), obtained by comminuting | |
| | high-purity mineral gypsum and then | |
| | calcining the comminuted powder to | |
| | insoluble anhydrite form | |

Materials, other than the sample reinforcing agents, are as follows:
Polypropylene—Profax 6301 (Equister) Homopolymer flakes, 12 MFR;
B225—BASF Anti-oxidant Iraganox 1010 and heat stabilizer Irgafos 168;
Zinc stearate—Acid neutralizer;
Calcium stearate—Acid neutralizer; and
MD 1024—metal deactivator (BASF, Ciba Geigy).

### Example 1

Test formulations of reinforced polypropylene are prepared. To prepare each test formulation, 0.15% B225, 0.1% zinc stearate and 0.15% MD 1024 are dry blended with polypropylene flakes. Sample reinforcing agent is blended with polypropylene flakes in a dry blender prior to compounding. Sample WA is pre-dried at 100 C for 16 hours prior to compounding and the other powders are not subjected to additional drying. The dry blends of are melt mixed using 40:1 L/D, 25 mm OD, ZE-25 co-rotating twin screw extruder. The dry blends are fed at the main feed port with feeder auger speed adjusted to 125 rpm to get 3 kg/hour rate with screw speed of 350 rpm. The barrel temperatures are set to: Feeder-360-375-390-410-410-420-420° F. Strands are air cooled and pelletized. ASTM test specimens are molded using Battenfeld 30 T machine at 375-390-410° F. with 60 psi back pressure, 250 rpm screw speed, 1500 psi injection pressure, and 20 seconds cooling time. A control formulation with polypropylene and the same amount of stabilizers, but without a sample reinforcing agent, is also melt mixed using a twin screw extruder prior to molding test specimens. In addition to the control formulation, various test formulations are prepared with approximately 5%, 20% or 40% loading of WA, WB, WC, WD or G sample reinforcing agents.

Molded samples are conditioned at 23° C. for 18 hours prior to testing. The following tests are conducted on molded samples:
(1) Melt flow rate (MFR)—ASTM D 1238—230° C., 2160 gm weight, 5 minute preheat;
(2) Density—ASTM D 792—23° C.;
(3) Tensile modulus, % elongation strength—ASTM D 638, Type IV bars, 2 ipm speed;

(4) Flexural strength and modulus—ASTM D 790—125 mil thick bars, 0.5 ipm, 23° C.;
(5) Notched Izod Impact strength—ASTM D 256, 7.5 J hammer, 125 mil thick samples;
(6) Unnotched Izod Impact strength—ASTM D 256, 7.5 J hammer, 124 mil thick sample;
(7) Gardner Impact strength—ASTM 5628, 2 lb hammer, ½″ D tup-125 mil thick discs;
(8) heat distortion temperature (HDT), ASTM D 648, 2° C./minute, 100 mm span, 66 psi and 264 psi fiber stress, 125-250 mil thick samples;
(9) Ash test, 850° C., 30 minutes in air; and
(10) Extrusion of films to check for dispersion.

The following tests are conducted on the sample reinforcing agents only:
(1) Bulk density; and
(2) Color L*a*b*C and brightness of CSW samples.

Results are summarized in Tables 2-5. All but sample reinforcing agent G had very low bulk density.

During film extrusion at 190° C., some volatiles fumes were coming off for all but formulations with sample G. The MFR of test compositions did not increase significantly even when the sample reinforcing agent loading was increased from 5 to 40 w/w. Normally MFR will decrease with addition of filler. Extruded films did not show any visible sign of aggregates. However, there seems to be water or volatiles in compounds.

Remarkably, the test formulations containing 5% of the granular sample G performed generally as well as or better than test formulations containing 5% of the whisker samples WA, WB, WC or WD. In particular the 5% G test formulation showed a higher flexural modulus, 1%, and a higher flexural strength than the any of the other 5% samples, including WD. This would be unexpected for a granular material as compared to a fiber, or whisker, material.

The densities reported for the 40% WC and 40% WD test formulations appear larger than expected and may have problems.

TABLE 2
Sample Reinforcing Agent Measured Properties

| | WA | WB | WC | WD | G |
|---|---|---|---|---|---|
| Bulk density, | 0.358 | 0.327 | 0.326 | 0.401 | 0.605 |
| untapped g/cc | | | | | |
| a | 0.23 | 0.16 | 0.21 | 0.49 | 0.2 |
| b | 0.97 | 0.92 | 0.85 | 1.09 | 0.42 |
| L | 96.54 | 96.04 | 95.22 | 96.53 | 96.93 |
| Berge Brightness | 85.78 | 85.04 | 83.39 | 84.58 | 89.65 |
| ASTM E 313 | 2.01 | 1.87 | 1.79 | 2.44 | 0.94 |
| Yellowness | | | | | |

TABLE 3
Control And 5%Test Formulations

| | | | | Test Formulations | | | | |
|---|---|---|---|---|---|---|---|---|
| No. | | ASTM | | | 5% | 5% | 5% | |
| Samples | Property | Test | | Control | WA | WB | WD | 5% G |
| 2 | Ash , 850 C., 30 minutes | | | | | | | |
| | Residue % | | | 0 | 5.7 | 6 | 6.1 | 5.1 |
| | Residue % | | | 0 | 5.9 | 4.6 | 6.2 | 4.9 |
| | Average | | | 0 | 5.8 | 5.3 | 6.15 | 5 |
| | Shore D Hardness | | 23 C. | 75 +/− 2 | 73 +/− 1 | 74 +/− 1 | 74 +/− 1 | 74 +/− 1 |
| | Barcol Hardness | | 23 C. | 45 | 47 | 47 | 53 | 53 |
| 5 | Specific Gravity, g/cc, 23 | D792 | g/cc | 0.903 | 0.939 | 0.939 | 0.945 | 0.938 |
| | C. | | | | | | | |
| 5 | MFR, 230 C., 2160 gms | D1238 | g/10′ | 11 | 10.22 | 10.6 | 11 | 11 |
| 5 | Tensile Strength, 23 C., 2 | D638 | psi | 4679 | 4617 | 4665 | 4632 | 4724 |
| | ipm | | | | | | | |
| 5 | % el @ yield, 23 C., 2 ipm | D638 | % | 12 | 12 | 11 | 12 | 11 |
| 5 | % el @ break, 23 C., 2 | D638 | % | 80 | 46 | 31 | 53 | 27 |
| | ipm | | | | | | | |
| 3 | Tensile Modulus, 0.5 | D638 | kpsi | 178 | 187 | 194 | 209 | 211 |
| | ipm, 0.5-5 lb | | | | | | | |
| 3 | Tensile Modulus, 5-10 lb | D638 | kpsi | 155 | 174 | 178 | 177 | 190 |
| 5 | 1% Secant modulus | D638 | Kpsi | 87 | 80 | 91 | 84 | 87 |
| 5 | Flex Mod, Tangent, Kpsi, | D790 | Kpsi | 188 | 202 | 245 | 271 | 265 |
| | 0.025-0.5% | | | | | | | |
| 5 | Flex modulus, 1%, Kpsi | D790 | Kpsi | 187 | 198 | 236 | 256 | 263 |
| 5 | Flex Strength, psi | D790 | psi | 5420 | 5591 | 6203 | 6517 | 6900 |
| 5 | Unnotched Izod Impact, | D256 | ft-lb/inc | NB | NB | 13.46 | NB | NB |
| | Avg | | | | | | | |
| 5 | Unnotched Izod Impact, | D256 | ft-lb/inc | NB | NB | 3.44 | NB | NB |
| | sdt. dev | | | | | | | |
| 10 | Notched Izod impact ft- | D256 | ft-lb/in | 0.4 | 0.46 | 0.37 | 0.6 | 0.44 |
| | lb/in, mean | | | | | | | |
| 10 | Notched Izod impact ft- | D256 | ft-ln/in | 0.05 | 0.048 | 0.05 | 0.081 | 0.05 |
| | lb/in, std. dev | | | | | | | |
| 10 | Notched impact break | D256 | CB/HB/PB | CB | CB | CB | CB | CB |
| | mode | | | | | | | |
| 10 | Gardener Drop Impact | D5420 | lb-inch | 72 | 12 | 12 | 11 | 18 |
| 2 | HDT, 66 psi | D648 | C. | 59 | 61 | 77.3 | 61.6 | 67.1 |
| | | | | 55 | 64.6 | 73.1 | 70 | 67 |
| | Average of two | D648 | C. | 57 | 62.8 | 75.2 | 65.8 | 67.05 |
| 2 | HDT, 264 psi, 13 mm × | D648 | C. | 101.2 | 108.6 | 109.1 | 102.5 | 87 |
| | 6.25 mm × 100 | | | | | | | |
| | | | | 103 | 109 | 113.2 | 124 | 81 |
| | Average of two | D648 | C. | 102.1 | 108.8 | 111.15 | 113.25 | 84 |

TABLE 4
20% Test Formulations

| No. | | ASTM | | Test Formulations | | |
|---|---|---|---|---|---|---|
| Samples | Property | Test | | 20% WB | 20% WD | 20% G |
| 2 | Ash , 850 C., 30 minutes | | | | | |
| | Residue % | | | 18.2 | 19.6 | 18.6 |
| | Residue % | | | 18 | 19.1 | 18.6 |
| | Average | | | 18.1 | 19.35 | 18.6 |
| | Shore D Hardness | | 23 C. | 75 +/− 1 | 75 +/− 1 | 76 +/− 1 |
| | Barcol Hardness | | 23 C. | 52 | 54 | 55 |
| 5 | Specific Gravity, g/cc, 23 C. | D792 | g/cc | 1.03 | 1.045 | 1.029 |
| 5 | MFR, 230 C, 2160 gms | D1238 | g/10′ | 12.6 | 11 | 10 |
| 5 | Tensile Strength, 23 C., 2 ipm | D638 | psi | 4452 | 4638 | 4547 |
| 5 | % el @ yield, 23 C., 2 ipm | D638 | % | 10 | 8.6 | 9.4 |
| 5 | % el @ break, 23 C., 2 ipm | D638 | % | 21 | 18 | 18 |
| 3 | Tensile Modulus, 0.5 ipm, 0.5- | D638 | kpsi | 248 | 331 | 218 |
| | 5 lb | | | | | |
| 3 | Tensile Modulus, 5-10 lb | D638 | kpsi | 216 | 270 | 210 |
| 5 | 1% Secant modulus | D638 | Kpsi | 93 | 91 | 85 |
| 5 | Flex Mod, Tangent, Kpsi, | D790 | Kpsi | 388 | 441 | 346 |
| | 0.025-0.5% | | | | | |
| 5 | Flex modulus, 1%, Kpsi | D790 | Kpsi | 343 | 389 | 333 |
| 5 | Flex Strength, psi | D790 | psi | 7339 | 7893 | 7663 |
| 5 | Unnotched Izod Impact, Avg | D256 | ft-lb/inc | 11.51 | 10.85 | 14.13 |
| 5 | Unnotched Izod Impact, | D256 | ft-lb/inc | 1.01 | 1.84 | 1.56 |
| | sdt. dev | | | | | |
| 10 | Notched Izod impact ft-lb/in, | D256 | ft-lb/in | 0.48 | 0.41 | 0.35 |
| | mean | | | | | |
| 10 | Notched Izod impact ft-lb/in, | D256 | ft-ln/in | 0.06 | 0.054 | 0.159 |
| | std. dev | | | | | |
| 10 | Notched impact break mode | D256 | CB/HB/ | CB | CB | CB |
| | | | PB | | | |
| 10 | Gardener Drop Impact | D5420 | lb-inch | 10 | 12 | 17 |
| 2 | HDT, 66 psi | D648 | C. | 66 | 72.6 | 62.5 |
| | | | | 66 | 73 | 59.1 |
| | Average of two | D648 | C. | 66 | 72.8 | 60.8 |
| 2 | HDT, 264 psi, 13 mm × 6.25 | D648 | C. | 137 | 127.2 | 128 |
| | mm × 100 | | | | | |
| | | | | 84 | 136 | 130 |
| | Average of two | D648 | C. | 110.5 | 131.6 | 129 |

TABLE 5
Control And 40% Test Formulations

| | | | | Test Formulations | | | |
|---|---|---|---|---|---|---|---|
| No. | | ASTM | | 40% | 40% | 40% | 40% |
| Samples | Property | Test | | WB | WC | WD | G |
| 2 | Ash, 850 C, 30 minutes | | | | | | |
| | Residue % | | | 37 | 37.4 | 37.3 | 38 |
| | Residue % | | | 37 | 36.9 | 36.9 | 38 |
| | Average | | | 37 | 37.15 | 37.1 | 38 |
| | Shore D Hardness | | 23 C. | 77 | 77 | 77 | 76 |
| | Barcol Hardness | | 23 C. | 59 | 61 | 59 | 59 |
| 5 | Specific Gravity, g/cc, 23 | D792 | g/cc | 1.21 | 1.25 | 1.259 | 1.204 |
| | C. | | | | | | |
| 5 | MFR, 230 C., 2160 gms | D1238 | g/10′ | 12.6 | 13.2 | 12.9 | 9 |
| 5 | Tensile Strength, 23 C., 2 | D638 | psi | 4145 | 4274 | 4249 | 4266 |
| | ipm | | | | | | |
| 5 | % el @ yield, 23 C., 2 ipm | D638 | % | 7 | 6 | 5 | 5 |
| 5 | % el @ break, 23 C., 2 | D638 | % | 16 | 13 | 11 | 10 |
| | ipm | | | | | | |
| 3 | Tensile Modulus, 0.5 | D638 | kpsi | NA | 448 | 407 | 291 |
| | ipm, 0.5-5 lb | | | | | | |
| 3 | Tensile Modulus, 5-10 lb | D638 | kpsi | 340 | 348 | 361 | 268 |
| 5 | 1% Secant modulus | D638 | Kpsi | 95 | 160 | 271 | 203 |
| 5 | Flex Mod, Tangent, Kpsi, | D790 | Kpsi | 558 | 617 | 704 | 453 |
| | 0.025-0.5% | | | | | | |
| 5 | Flex modulus, 1%, Kpsi | D790 | Kpsi | 467 | 505 | 542 | 418 |
| 5 | Flex Strength, psi | D790 | psi | 7952 | 8014 | 8535 | 7983 |
| 5 | Unnotched Izod Impact, | D256 | ft-lb/inc | 5.73 | 5.44 | 5.88 | 6.74 |
| | Avg | | | | | | |
| 5 | Unnotched Izod Impact, | D256 | ft-lb/inc | 0.42 | 0.53 | 0.156 | 1.55 |
| | sdt. dev | | | | | | |
| 10 | Notched Izod impact ft- | D256 | ft-lb/in | 0.29 | 0.28 | 0.29 | 0.32 |
| | lb/in, mean | | | | | | |
| 10 | Notched Izod impact ft- | D256 | ft-ln/in | 0.129 | 0.137 | 0.137 | 0.154 |
| | lb/in, std. dev | | | | | | |
| 10 | Notched impact break | D256 | CB/HB/P | CB | CB | CB | CB |
| | mode | | B | | | | |
| 10 | Gardener Drop Impact | D5420 | lb-inch | 12 | 10 | 12 | 9 |
| 2 | HDT, 66 psi | D648 | C. | 104.3 | 98 | 95.4 | 85.3 |
| | | | | 107.6 | 103.6 | 106 | 81 |
| | Average of two | D648 | C. | 105.95 | 100.8 | 100.7 | 83.15 |
| 2 | HDT, 264 psi, 13 mm × | D648 | C. | 143.2 | 142.3 | 140.8 | 136 |
| | 6.25 mm × 100 | | | | | | |
| | | | | 139.8 | 141.7 | 141 | 140.6 |
| | Average of two | D648 | C. | 141.5 | 142 | 140.9 | 138.3 |

### Example 2

Test formulations of reinforced polypropylene are prepared in a manner similar to Example 1. In each formulation, 0.45% B225, 0.25% calcium stearate and 0.45% MD 1024 are dry blended with polypropylene flakes. Sample reinforcing agent is blended with polypropylene flakes in a dry blender and then compounded, extruded and tested in a manner similar to Example 1. Test formulations are prepared with approximately 2.5%, 5%, and 15% of WD or G sample reinforcing agent powder. Results are summarized in Table 6.

TABLE 6

| No. | | ASTM | | Test Formulations | | | | | | | |
|---|---|---|---|---|---|---|---|---|---|---|---|
| Samples | Property | Test | | 2.5% WD | 5% WD | 10% WD | 15% WD | 2.5% G | 5% G | 10% G | 15% G |
| 2 | Ash , 850 C., 30 minutes | | | | | | | | | | |
| | Residue % | | | 3 | 6.1 | 9.9 | 15.4 | 2.42 | 5.1 | 10.99 | 14 |
| | Residue % | | | 3 | 6.2 | 10.21 | 15.54 | 2.98 | 4.9 | 10.01 | 14 |
| | Average | | | 3 | 6.15 | 10.055 | 15.47 | 2.7 | 5 | 10.5 | 14 |
| | Shore D Hardness | | 23° C. | 72 +/− 2 | 74 +/− 1 | 75 +/− 1 | 75 +/− 1 | 70 | 74 +/− 1 | 75 +/− 1 | 76 +/− 1 |
| | Barcol Hadrness | | 23° C. | 48 | 52 | 52 | 52 | 48 | 53 | 52 | 52 |
| 5 | Specific Gravity, g/cc, | D792 | g/cc | 0.92 | 0.937 | 0.967 | 0.997 | 0.922 | 0.938 | 0.968 | 1.011 |
| | 23 C. | | | | | | | | | | |
| 5 | MFR, 230 C, 2160 gms | D1238 | g/10' | 11.4 | 13 | 13 | 12.6 | 11.5 | 11.6 | 11.6 | 12 |
| 5 | Tensile Strength, 23 C., | D638 | psi | 4854 | 4846 | 4879 | 4988 | 4815 | 4893 | 4854 | 4609 |
| | 2 ipm | | | | | | | | | | |
| 5 | % el @ yield,23 C., | D638 | % | 11 | 11 | 10 | 9 | 12 | 12 | 10 | 9 |
| | 2 ipm | | | | | | | | | | |
| 5 | % el @ break, 23 C., | D638 | % | 94-350 | 82-363 | 60-130 | 24 | 88-536 | 72-500 | 48-190 | 22 |
| | 2 ipm | | | | | | | | | | |
| 3 | Tensile Modulus, | D638 | kpsi | 175 | 187 | 203 | 223 | 175 | 181 | 192 | 196 |
| | 0.5 ipm, 0.5-5 lb | | | | | | | | | | |
| 3 | Tensile Modulus, 5-10 lb | D638 | kpsi | 162 | 172 | 193 | 228 | 167 | 183 | 185 | |
| 5 | 1% Secant modulus | D638 | Kpsi | 109 | 116 | 120 | 130 | 111 | 112 | 116 | 130 |
| 5 | Flex Mod, Tangent, | D790 | Kpsi | 227 | 233 | 283 | 317 | 223 | 241 | 249 | 258 |
| | Kpsi, 0.025-0.5% | | | | | | | | | | |
| 5 | Flex modulus, 1%, Kpsi | D790 | Kpsi | 223 | 225 | 277 | 297 | 218 | 235 | 242 | 252 |
| 5 | Flex Strength, psi | D790 | psi | 6182 | 6370 | 6552 | 7057 | 6097 | 6370 | 6514 | 6664 |
| 5 | Unnotched Izod Impact, | D256 | ft-lb/inc | NB | 13.45 | 11.74 | 12.56 | NB | NB | 14 | 11.4 |
| | Avg | | | | | | | | | | |
| 5 | Unnotched Izod Impact, | D256 | ft-lb/inc | NB | 1.22 | 2.68 | 1.29 | NB | NB | 1.52 | 1.5 |
| | sdt. dev | | | | | | | | | | |
| 10 | Notched Izod impact | D256 | ft-lb/in | 0.53 | 0.6 | 0.55 | 0.53 | 0.52 | 0.57 | 0.55 | 0.51 |
| | ft-lb/in, mean | | | | | | | | | | |
| 10 | Notched Izod impact | D256 | ft-ln/in | 0.073 | 0.05 | 0.024 | 0.018 | 0.025 | 0.061 | 0.032 | 0.074 |
| | ft-lb/in, std. dev | | | | | | | | | | |
| 10 | Notched impact break | D256 | CB/HB/ | CB | CB | CB | CB | CB | CB | CB | CB |
| | mode | | PB | | | | | | | | |
| 10 | Gardener Drop Impact | D5420 | lb-inch | 30 | NA | 14 | NA | NA | 18 | NA | NA |
| 2 | HDT, 66 psi | D648 | ° C. | 64.8 | 64.7 | 72 | 83.5 | 59.5 | 66 | 62.4 | 71.2 |
| | | | | 66.7 | 65.3 | 72 | 82.7 | 60.2 | 66 | 65.3 | 73.3 |
| | Average of two | D648 | ° C. | 65.75 | 65 | 72 | 83.1 | 59.85 | 66 | 63.85 | 72.25 |
| 2 | HDT, 264 psi, 13 mm × | D648 | ° C. | 113.9 | 109.6 | 128.9 | 132.4 | 97.5 | 108 | 111.9 | 116 |
| | 6.25 mm × 100 | | | | | | | | | | |
| | | | | 113.4 | 105.9 | 131.3 | 128.2 | 97.9 | 113.8 | 113.2 | 118 |
| | Average of two | D648 | ° C. | 113.65 | 107.75 | 130.1 | 130.3 | 97.7 | 110.9 | 112.55 | 117 |

As shown in Table 6, the G samples perform generally as well as the WD samples at the lower concentrations, with performance particularly good at 5% loading. The WD samples at 15% loading are starting to diverge to a greater degree, and as shown in Example 1 at loadings of 20% and higher the unnotched Izod impact strength of G formulations drops significantly. The high performance of the test formulations with a low loading of sample granular reinforcing agent G relative to corresponding test formulations with whisker-containing sample reinforcing agent WD is remarkable, especially at concentrations of less than 15%, with performance for 2.5% and 5% G formulations being especially good relative to the WD formulations.

The foregoing discussion of the invention and different aspects thereof has been presented for purposes of illustration and description. The foregoing is not intended to limit the invention to only the form or forms specifically disclosed herein. Consequently, variations and modifications commensurate with the above teachings, and the skill or knowledge of the relevant art, are within the scope of the present invention. The embodiments described hereinabove are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art. Although the description of the invention has included description of one or more possible implementations and certain variations and modifications, other variations and modifications are within the scope of the invention, e.g., as may be within the skill and knowledge of those in the art after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. Furthermore, any feature described or claimed with respect to any disclosed aspect, embodiment or implementation may be combined in any combination with one or more of any other features of any other aspect, embodiment or implementation to the extent that the features are not necessarily technically incompatible, and all such combinations are within the scope of the present invention.

The terms “comprising”, “containing”, “including” and “having”, and grammatical variations of those terms, are intended to be inclusive and nonlimiting in that the use of such terms indicates the presence of some condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or the appropriate grammatical variation of such narrower terms). For example, a statement that some thing “comprises” a stated element or elements is also intended to include and disclose the more specific narrower embodiments of the thing “consisting essentially of” the stated element or elements, and the thing “consisting of” the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all. All concentrations disclosed herein are on a weight basis unless otherwise stated or otherwise apparent from the context.

What is claimed is:

1. A reinforced polyolefin composition comprising a polyolefin polymer component and from 2 weight percent to 17 weight percent of a granular particulate anhydrite reinforcing agent having a weight average particle size of not larger than 20 microns.

2. A reinforced polyolefin composition according to claim 1, comprising from 2.5 weight percent to 7.5 weight percent of the anhydrite reinforcing agent.

3. The reinforced polyolefin composition according to either one of claim 1 or claim 2, wherein the polyolefin polymer component consists essentially of polypropylene.

4. The reinforced polyolefin composition according to any one of claims 1-3, comprising at least 90 weight percent of the polyolefin polymer component.

5. The reinforced polyolefin composition according to any one of claims 1-4, wherein the anhydrite reinforcing agent has a weight average particle size of not larger than 12 microns.

6. The reinforced polyolefin composition according to any one of claims 1-5, wherein the anhydrite reinforcing agent comprises comminuted calcium sulfate dihydrate mineral calcined to insoluble anhydrite.

7. The reinforced polyolefin composition according to any one of claims 1-6, comprising a flexural strength determined by ASTM D790 that is at least 15% larger than the flexural strength of a comparison composition that is the same except not including the anhydrite reinforcing agent.

8. The reinforced polyolefin composition according to claim 1, comprising:
from 2.5 weight percent to 7.5 weight percent of the anhydrite reinforcing agent; and
at least 90 weight percent of the polyolefin polymer component;
wherein the polyolefin polymer component consists essentially of polypropylene; and
wherein the anhydrite reinforcing agent has a weight average particle size of not larger than 12 microns.

9. The reinforced polyolefin composition according to claim 8, wherein the anhydrite reinforcing agent comprises comminuted calcium sulfate dihydrate mineral calcined to insoluble anhydrite.

10. The reinforced polyolefin composition according to claim 9, comprising a flexural strength determined by ASTM D790 that is at least 15% larger than the flexural strength of a comparison composition that is the same except not including the anhydrite reinforcing agent.

11. A product comprising the reinforced polyolefin composition according to any one of claims 8-10.

12. A product according to claim 11, wherein the product is for a transportation vehicle.

13. A method for making a product comprising the reinforced polyolefin composition according to any one of claims 8-10, the method comprising injection molding the reinforced polyolefin composition.

14. A product comprising the reinforced polyolefin composition according to any one of claims 1-7.

15. A method for making a product comprising the reinforced polyolefin composition according to any one of claims 1-7, the method comprising injection molding the reinforced polyolefin composition.

16. The subject matter according to either one of claim 14 or claim 15, wherein the product is for a transportation vehicle.

17. A granular particulate anhydrite reinforcing agent for polyolefin reinforcement having a weight average particle size of not larger than 20 microns.

18. The granular particulate anhydrite reinforcing agent according to claim 17, wherein the anhydrite reinforcing agent has a weight average particle size of not larger than 12 microns.

19. The granular particulate anhydrite reinforcing agent according to either one of claim 17 or claim 18, wherein the anhydrite reinforcing agent comprises comminuted calcium sulfate dihydrate mineral calcined to insoluble anhydrite.

20. Use of the granular particulate anhydrite reinforcing agent according to any one of claims 17-19 as a reinforcing agent for a polyolefin.

21. Use of the reinforced polyolefin composition according to any one of claims 1-10 for manufacture of a product for a transportation vehicle.
